(19) United States
(12) Patent Application Publication
(10) Pub. No.: US 2011/0113967 A1
(43) Pub. Date: May 19, 2011

(54) AUTOMATIC COCKTAIL MAKER

(76) Inventor: Bo LIN, Chengdu (CN)

(21) Appl. No.: 13/013,774

(22) Filed: Jan. 25, 2011

Related U.S. Application Data
(63) Continuation of application No. PCT/CN2009/073163, filed on Aug. 10, 2009.

(30) Foreign Application Priority Data
Aug. 12, 2008 (CN) 200810045787.8

(51) Int. Cl. B67D 1/08

(52) U.S. Cl. 99/275

(57) ABSTRACT

An automatic cocktail maker, including a frame, multiple can bodies, a multi-channel switching device including a liquid inlet and a liquid outlet, a measuring pump including an inlet hole and an outlet hole, a pipe system, and a programmable control unit. The can body is disposed on the frame, the pipe system operates to connect the can body with a liquor outlet, the can body is connected to the liquid inlet of the multi-channel switching device via a first honeycomb duct, the liquid outlet of the multi-channel switching device is connected to the inlet hole of the measuring pump via a second honeycomb duct, the outlet hole of the measuring pump is connected to a liquor outlet, and a drive portion of the multi-channel switching device and the measuring pump is electrically connected to the programmable control unit.

### CROSS-REFERENCE TO RELATED APPLICATIONS

This application is a continuation of International Patent Application No. PCT/CN2009/073163 with an international filing date of Aug. 10, 2009, designating the United States, now pending, and further claims priority benefits to Chinese Patent Application No. 200810045787.8 filed Aug. 12, 2008. The contents of all of the aforementioned applications, including any intervening amendments thereto, are incorporated herein by reference.

### BACKGROUND OF THE INVENTION

1. Field of the Invention

The invention relates to an automatic cocktail maker.

2. Description of the Related Art

Conventionally, cocktail is prepared manually, and requires elaboration of professional bartenders since requirement for a preparing technique is high. However, manual mixing is complex and low efficient and cocktail made thereby is very expensive. There are thousands of mixing methods for the cocktail, and people cannot remember all the methods. Moreover, a graduate is used during manual mixing, which easily causes measurement errors, and flavor of cocktail made thereby cannot meet requirements. All the above-mentioned reasons result in high price and unpopularity of the cocktail.

To solve the problem, research has been conducted on automatic cocktail makers in the prior art. A common-used cocktail maker comprises a housing, multiple can bodies disposed in the housing and operating to accommodate liquor, and multiple pipe systems each connecting the can body and a liquor outlet. An electromagnetic valve is disposed on a pipe system connected to each can body, and is controlled via a programmable chip. Outflow of liquor in different can bodies is determined by time of switching on or off the electromagnetic valve whereby implementing mixing according to a ration. An air-pressure system is added to the maker so that pressure in each can body and a flow velocity of liquor are constant whereby ensuring good mixing precision and preparing effect.

In the above-mentioned maker, to control addition amount of different liquor, the electromagnetic valve is disposed on a pipe system of each can body. As the number of the can bodies is large, the corresponding number of the electromagnetic valves is also large, which causes increase in production cost and maintenance cost. In addition, since a flow velocity of liquor from a can is not constant, outflow controlled by the time of switching on or off the electromagnetic valve is not very accurate.

### SUMMARY OF THE INVENTION

In view of the above-described problem, it is one objective of the invention to provide an automatic cocktail maker that is capable of implementing automatic and accurate mixing of cocktail, and features a simple pipe system and low production cost.

To achieve the above objectives, in accordance with one embodiment of the invention, provided is an automatic cocktail maker, comprising a frame, multiple can bodies, a multi-channel switching device comprising a liquid inlet and a liquid outlet, a measuring pump comprising an inlet hole and an outlet hole, a pipe system, and a programmable control unit. The can body is disposed on the frame, the pipe system operates to connect the can body with a liquor outlet, the can body is connected to the liquid inlet of the multi-channel switching device via a first honeycomb duct, the liquid outlet of the multi-channel switching device is connected to the inlet hole of the measuring pump via a second honeycomb duct, the outlet hole of the measuring pump is connected to a liquor outlet, and a drive portion of the multi-channel switching device and the measuring pump is electrically connected to the programmable control unit.

In a class of this embodiment, the measuring pump further comprises a pump sleeve, a pump body, a plunger, and a flow guide hole, the pump body is movably disposed in the pump sleeve, the plunger is disposed in a cavity of the pump body, the flow guide hole is disposed on side wall of the pump body and connected to the cavity, the inlet hole and the outlet hole are disposed on the pump sleeve, and the flow guide hole is alternatively aligned with the inlet hole and the outlet hole.

In a class of this embodiment, the multi-channel switching device comprises a first portion, a second portion, and a switching portion, a liquid-inlet channel connected to the liquid inlet and the liquid outlet corresponding to the can body is disposed on the first portion, a liquid outlet connected to the measuring pump, and a liquid-outlet channel connected to the liquid outlet are disposed on the second portion, the switching portion is disposed between the first portion and the second portion, and capable of moving with respect thereto, a flow guide channel is disposed on the switching portion, one end of the flow guide channel is connected to the liquid-outlet channel on the second portion, and the other end thereof is connected to a corresponding liquid-inlet channel as the switching portion is in different positions.

In a class of this embodiment, the switching portion is in the shape of a circular plate and capable of rotating with respect to a central axis thereof, and an end of the flow guide channel connected to the liquid-outlet channel is on the central axis of the circular plate.

In a class of this embodiment, the can bodies are divided into N groups, and N is an integer greater than or equal to 1, the number of the multi-channel switching devices and measuring pumps is N, each group comprises a can body, a multi-channel switching device, and a measuring pump, the can body in each group is connected to a liquid inlet of a corresponding multi-channel switching device via the first honeycomb duct, and the liquid outlet of the multi-channel switching device is connected to an inlet hole of a corresponding measuring pump.

In a class of this embodiment, the switching portion of the multi-channel switching device is driven by a servo motor, or a step motor with a rotary encoder, and the servo motor or the step motor is closed-loop controlled.

In a class of this embodiment, an evacuation channel inlet is disposed on the first portion of the multi-channel switching device, the evacuation channel inlet is connected to purified water or ambient air, and to an evacuation channel in the first portion, and the switching portion moves so that the flow guide channel connects the evacuation channel to the liquid-outlet channel of the second portion as the multi-channel switching device is in an evacuation state.

In a class of this embodiment, a liquor outlet head is removably disposed outside the liquid outlet, a flow guide portion is disposed on the liquor outlet head, and an end of the flow guide portion is contacted with inner wall of a wine glass.

In a class of this embodiment, a magnetic stirrer and an electric mixer are disposed at the liquor outlet.

In a class of this embodiment, a cooling device is disposed outside the can body.

In a class of this embodiment, magnetic sealing is used between the first portion, the second portion, and the switching portion.

In a class of this embodiment, a rotatable liquor outlet head is disposed outside the liquid outlet, and an outlet of the liquor outlet head faces wall of the cup.

Advantages of the invention comprise:

1. thousands of methods for producing cocktail are saved in the programmable control unit, and the programmable control unit implements mixing of the cocktail via the multi-channel switching device and the measuring pump, which cannot be done manually. Based on this, the programmable control unit can be controlled manually whereby adjusting ingredients, which facilitates creative preparing of the cocktail.

2. mixing of the cocktail is fast, compared with manual mixing of cocktail that takes several minutes, the invention only needs several seconds to tens of seconds, which improves efficiency and benefit, and makes the invention suitable for bars, hotels, restaurants, and families.

3. no electromagnetic valve is used for controlling outflow in the pipe system, which greatly reduces the number of the electromagnetic valves, and thus production cost and maintenance cost.

4. the piston-type measuring pump without a one-way valve is used, which implements accurate measuring and mixing. By scientific configuration, a range of the measuring pump can obtain better measuring effect. For example, a pump with an extraction amount of ⅙ ounce per stroke is selected, by calculating the number of extraction, it is possible to accurately obtain real extraction amount. Compared with conventional measuring pumps and electromagnetic pumps, the measuring pump is more suitable for measurement of mixed cocktail.

5. if the piston-type measuring pump without the one-way valve is used, the invention has better anti-impurity performance, milky and soft impurities containing fruit particles in liquor, as long as they do not cause blockage of the pipe system, will not bring effect to the measuring pump.

### BRIEF DESCRIPTION OF THE DRAWINGS

FIG. 1 is a side view of an automatic cocktail maker of an exemplary embodiment of the invention;

FIG. 2 is a front view of an automatic cocktail maker of FIG. 1;

FIG. 3 is a cross-sectional view of a measuring pump of an automatic cocktail maker of the invention;

FIG. 4 is a cross-sectional view of a measuring pump and a drive portion thereof;

FIGS. 5 and 6 illustrate a measuring pump and a drive portion thereof in different operating states of FIG. 4;

FIG. 7 is a schematic view of a multi-channel switching device of the invention;

FIG. 8 is a schematic view of a magnetic stirrer and an electric mixer disposed at a liquor outlet of the invention.

In the drawings, the following reference numbers are used:

1—can body; 3—multi-channel switching device; 3-1—drive motor of a multi-channel switching device; 4—first measuring pump; 4-1—drive motor of a first measuring pump; 5—second measuring pump; 5-1—drive motor of a second measuring pump; 6—stirring motor; 7—stirrer; 8—frame; 9—cold closet; 10—touch screen; 11—liquor outlet; 12—compressor; 13—control box; 15—liquid level display; 16—first honeycomb duct; 17—second honeycomb duct; 18—first portion; 19—second portion; 20—liquid inlet; 21—liquid outlet; 22—switching portion; 24—magnetic stirrer; 31—plunger; 32—pump body; 33—pump sleeve; 34—sliding block; 35—push-pull rod; 36—housing; 37—rotating block; 38—spring piece; 39—inlet hole; 40—outlet hole; 41—flow guide hole; 45—sealing strip; 46—adjusting screw; 47—sealing ring; 48—limit block; 49—limit ring; 50—elastic component; 51—cavity; 52—first groove; 53—second groove.

### DETAILED DESCRIPTION OF THE EMBODIMENTS

Further description of the invention will be given below in conjunction with accompanying drawings and specific embodiments.

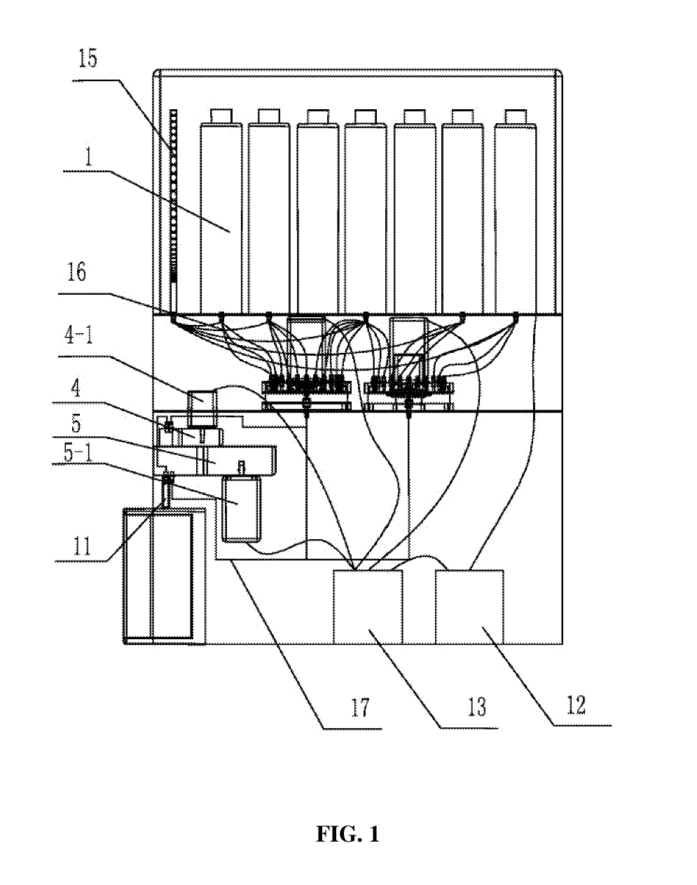

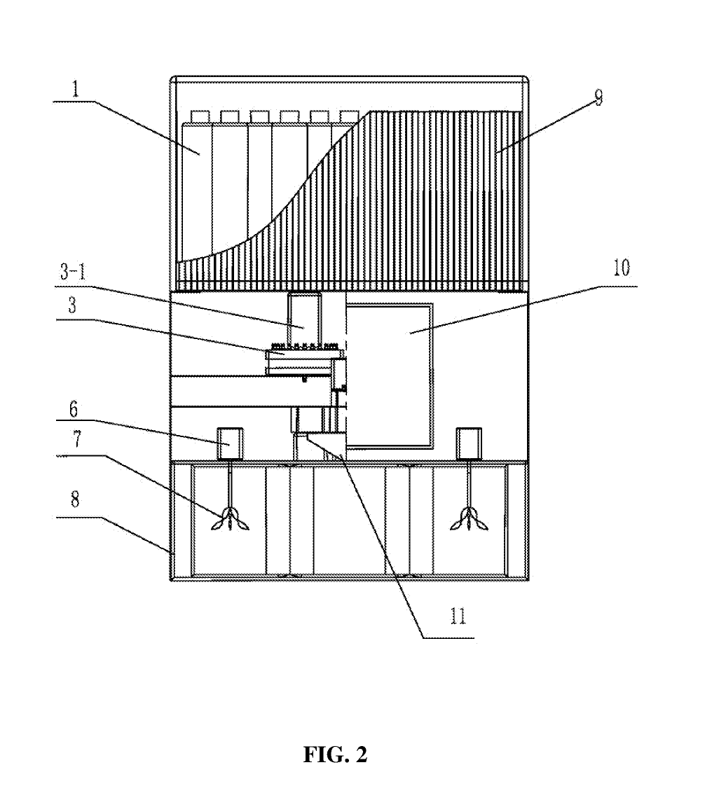

Embodiment 1, as shown in FIGS. 1, 2 and 7, an automatic cocktail maker of the invention comprises a frame 8, and multiple can bodies 1 disposed on the frame 8 and operating to accommodate different types of liquor. The can body 1 is connected to a liquid inlet 20 of a multi-channel switching device 3 via a first honeycomb duct 16, a liquid outlet 21 of the multi-channel switching device 3 is connected to an inlet hole 39 of a second measuring pump 5 via a second honeycomb duct 17, a liquid outlet 40 of a second measuring pump 5 is connected to a liquor outlet 11, a drive portion of the multi-channel switching device 3 and the second measuring pump 5 is electrically connected to a programmable control unit, the programmable control unit is disposed in a control box 13, the programmable control unit selects a can body 1 connected to the measuring pump by controlling the multi-channel switching device 3, and controls outflow of liquor in the can body 1 by controlling the measuring pump, and thus a cocktail is produced according to a stored ingredient.

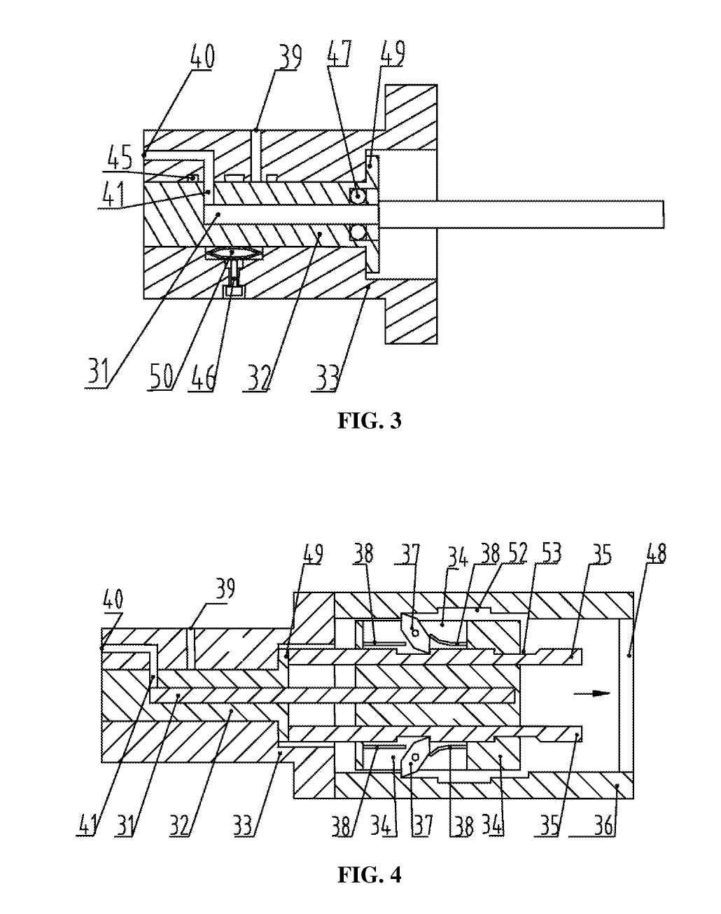

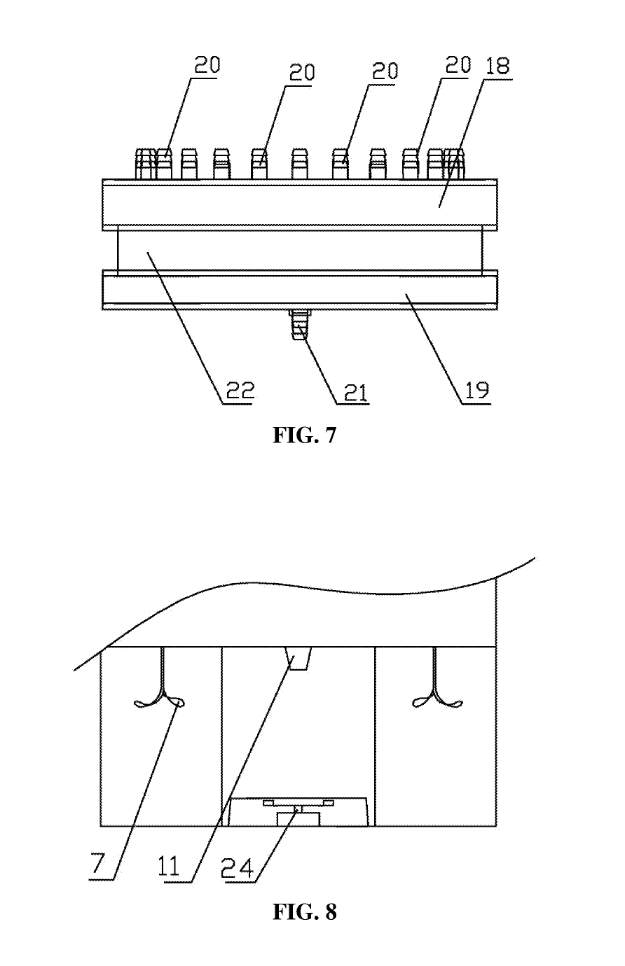

Embodiment 2, as shown in FIGS. 1, 2 and 7, an optimized automatic cocktail maker comprises a frame 8, and multiple can bodies 1 disposed on the frame 8 and operating to accommodate different types of basic liquor and beverage. The can body 1 is disposed in a cold closet 9, the cold closet 9 is driven by a compressor 12, and capable of controlling temperature of the liquor and the beverage within 4 to 8° C. A tee is connected to the bottom of each can body 1, and one outlet of the tee is connected to a liquid level display 15 whereby indicating residual capacity of liquid in the can body 1 (not shown), and the other outlet thereof is connected to a liquid inlet 20 of the multi-channel switching device 3 via a soft pipe in the first honeycomb duct 16. As shown in FIG. 7, the multi-channel switching device 3 comprises a first portion 18, a second portion 19, and a switching portion 22. The first portion 18 and the second portion 19 are rectangular blocks with similar shapes, and the switching portion 22 in the shape of a circular plate is disposed between the first portion 18 and the second portion 19, and capable of rotating with respect to a central axis thereof. Multiple liquid inlets 20 corresponding to the can bodies 1 are disposed on the first portion 18, and capable of connecting tens of can bodies 1 accommodating different types of basic liquor and beverage. A liquid outlet 21 is disposed on the second portion 19 and connected to an inlet hole 39 of the second measuring pump 5. A liquid-inlet channel connected to the liquid inlet 20 is disposed in the first portion 18, and a liquid-outlet channel connected to the liquid outlet 21 is disposed in the second portion 19. The switching portion 22 is driven by a servo motor controlled by the programmable control unit, or by a step motor with a rotary encoder, and the servo motor or the step motor is closed-loop controlled. As the switching portion 22 rotates to different positions, both ends of the flow guide channel are respectively connected to the liquid-outlet channel and a liquid-inlet channel in a corresponding position whereby connecting the second measuring pump 5 to a selected can body 1. The outlet hole 40 of the second measuring pump 5 is connected to the liquor outlet whereby discharging extracted basic liquor or beverage. A preferred measuring pump 5 is shown in FIG. 3, and comprises a pump sleeve 33, a pump body 32 movably disposed in the pump sleeve 33, a plunger 31 disposed in a cavity 51 in the pump body 32, a sealing ring 47 disposed between the plunger 31 and the pump body 32, a flow guide hole 41 disposed on side wall of the pump body 32 and connected to the cavity 51, and an inlet hole 39 and an outlet hole 40 disposed on the pump sleeve 33. Openings of the inlet hole 39 and the outlet hole 40 on inner side of the pump sleeve 33 are on a movement track of the flow guide hole 41 on the pump body 32. Sealing strips 45 are disposed in the vicinity of the inlet hole 39 and the outlet hole 40. An elastic component 50 is disposed at the back of the inlet hole 39 and the outlet hole 40, and between the pump sleeve 33 and the pump body 32, and an adjusting screw fit therewith is capable of adjusting contact pressure between the pump body 32 and the pump sleeve 33 whereby maintaining tightness between the pump sleeve 33 and the pump body 32. Sliding of the pump body 32 in the pump sleeve 33 can switch connection states between the flow guide hole 41 and the inlet hole 39 or the outlet hole 40. Movement of the plunger 31 in the pump body 32, and connection states between the flow guide hole 41 and the inlet hole 39 or the outlet hole 40 facilitates liquid extraction and emission according to a ration. Since the second measuring pump 5 uses no one-way valve, errors caused by the one-way valve are prevented, which makes the invention especially suitable for accurately measuring liquid with small dose. Movement of the pump body 32 and the plunger 31 is driven by the drive motor of the second measuring pump 5-1. The drive motor of the multi-channel switching device 3-1 and the drive motor of the second measuring pump 5-1 are controlled by the programmable control unit. The programmable control unit controls switching states of the multi-channel switching device 3, and extraction dose of the second measuring pump 5, whereby producing a cup of cocktail according to a stored ingredient.

In embodiment 2, to improve sealing performance of the multi-channel switching device 3, magnetic sealing is used between the first portion 18, the second portion 19, and the switching portion 22.

Embodiment 3, based on embodiment 2, all the can bodies 1 are divided into two groups, two multi-channel switching devices 3 are corresponding to the two groups of can bodies 1, and two measuring pumps, namely the first measuring pump 4 and the second measuring pump 5, are used. The can body 1 in each group is connected to a liquid inlet 20 of a corresponding multi-channel switching device 3 via the first honeycomb duct 16, and the multi-channel switching device 3 is connected to the measuring pump via the second honeycomb duct 17 whereby forming a set of liquor-mixing channel. Two groups of liquor-mixing channels can simultaneously extract liquor into a wine glass, which reduces preparing time. Based on this embodiment, the number of groups of the can bodies 1, that of the multi-channel switching devices 3, and that of the measuring pumps can be increased as required, or measuring pumps with different measurement ranges are matched with each other whereby improving precision of measurement.

In the above-mentioned embodiment, if condiments such as bitters, grenadine and so on need to be added drop by drop, since the number of the condiments is small, the electromagnetic valve can be directly used in a container accommodating the condiments such as bitters, grenadine and so on whereby controlling addition amount.

Based on embodiments 2 and 3, to prevent tainting by odor during next time caused by residual liquor or beverage in the soft pipe after mixing of liquor is completed, an evacuation channel inlet is disposed outside the first portion 18 of the multi-channel switching device 3, and operates to connect purified water or ambient air. The evacuation channel inlet is connected to an evacuation channel in the first portion 18. As the multi-channel switching device 3 is in an evacuation state, the flow guide channel in the switching portion 22 connects the evacuation channel to the liquid-outlet channel of the second portion so that the second measuring pump 5 extracts air or purified water, and evacuates residual liquid in the pipe system. For example, after mixing of liquor and a last extraction stroke of the second measuring pump 5 are completed, the programmable control unit controls the switching portion 22 of the multi-channel switching device 3 to rotate whereby connecting the inlet hole 39 of the measuring pump to the evacuation channel inlet, and the second measuring pump 5 to finish an empty stroke and emit residual liquid in the soft pipe. Multiple evacuation channel inlets can be used and are interval arranged along with the liquid inlets 20, whereby making it convenient to select the switching portions 22.

As shown in FIG. 4, a preferable drive device of a measuring pump in embodiment 2 comprises a housing 36 fixedly connected to the pump sleeve 33, a push-pull rod 35 fixed to the pump body 32, a sliding block 34 movably disposed in the housing 36, and a limit ring 49 disposed at the tail of the pump body 32. The limit ring 49 is fit with the pump sleeve 33 whereby limiting movement of the pump body 32 to the left. A limit block 48 is disposed on the right of the housing 36 whereby limiting movement of the push-pull rod 35 to the right. The limit ring 49 is fit with the limit block 48 whereby limiting sliding of the pump body 32 in the pump sleeve 33. The plunger 31 is fixedly connected to the sliding block 34, the push-pull rod 35 passes through the sliding block 34, a shaft is disposed on the sliding block 34 between the push-pull rod 35 and the housing 36, a rotating block 37 is disposed on the shaft, a pair of spring pieces 38 is disposed on both sides of the rotating block 37, and the top of the spring piece 38 is contacted with one side of the rotating block 37. A pair of second grooves 53 is disposed on the push-pull rod 35 opposite to the housing 36, and a first groove 52 is disposed on inner side of the housing 36 opposite to the second groove 53. The first groove 52 is divided into three parts, and a middle part is lower than the other parts. An end of the rotating block 37 slides in the first groove 52 of the housing 36, and the other end slides in the second groove 53 on the push-pull rod 35, and between the second grooves 53. The sliding block 34 is driven by the drive motor of the measuring pump via a linkage part and moves reciprocally

A process of driving the measuring pump by the drive device is as follows:

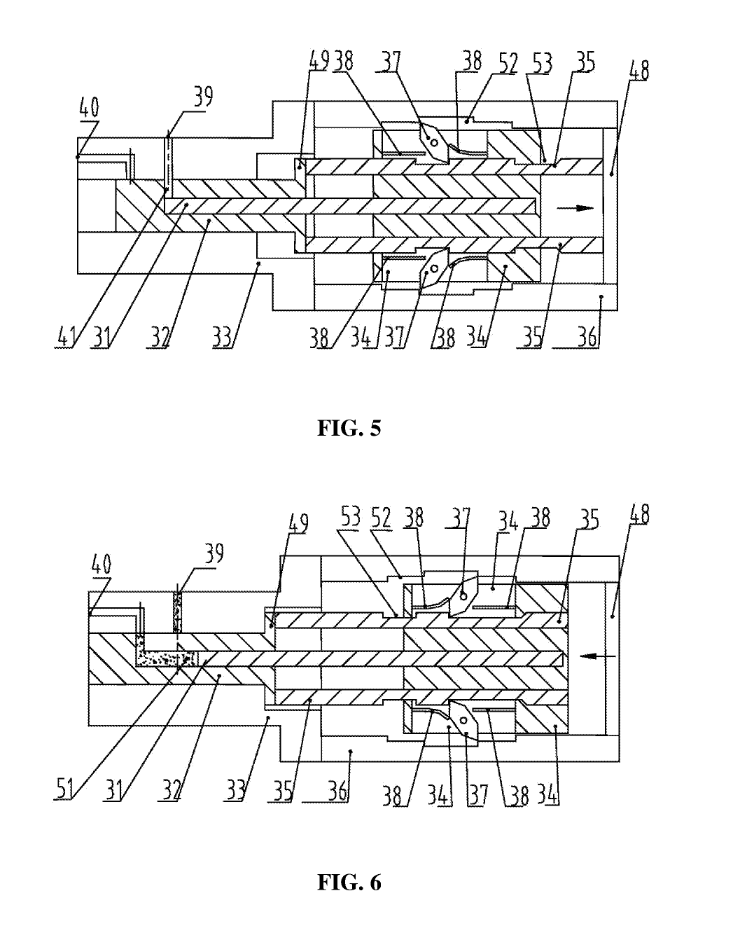

The drive motor of the measuring pump drives the sliding block 34 to move back and forth for one time, and thus a liquid extraction and emission process is completed. During the liquid extraction process, as shown in FIG. 4, the sliding block 34 moves to the right, both ends of the rotating block 37 disposed on the sliding block 34 are in grooves on the housing 36 and the push-pull rod 35. Since a distance between a left part of the first groove 52 on the housing 36 and the rotating block 37 is small, the rotating block 37 is limited by the left part of the first groove 52 on the housing 36 and cannot rotate, and is locked on one end of the left second groove 53 on the push-pull rod 35 whereby driving the push-pull 35 to move to the right, and forcing the pump body 32 to move to the right along with the plunger 31. As shown in FIG. 5, as the end of the rotating block 37 contacted with the housing 36 moves to the middle part of the first groove 52 on the housing 36, since the middle part of the first groove 52 is lower than the other parts, rotation of the rotating block 37 cannot be limited, and the push-pull rod 35 is limited by the limit block 48 and cannot move to the right, the flow guide hole 41 on the pump body 32 is connected to the inlet hole 39, and the outlet hole 40 is blocked by the pump body 32. As the sliding block 34 continues to move to the right, the plunger 31 moves along therewith, the plunger 31 moves with respect to the pump body 32, and the liquid extraction process is completed. Meanwhile, the left second groove 53 on the push-pull rod 35 drives the rotating block 37 to rotate, the end of the rotating block 37 contacted with the push-pull rod 35 slides in the right second groove 53 on the push-pull rod 35, the spring piece 38 on the left of the rotating block 37 is compressed, and presses the rotating block 37 whereby enabling it to be tightly attached to grooves on both sides thereof, and the end of the rotating block 37 contacted with the housing 36 slides to a right part of the first groove 52. A following liquid emission process is shown in FIG. 6, the sliding block 34 moves to the left as being driven by the motor, the rotating block 37 is limited by the right part of the first groove 52 on the housing 36 and cannot rotate, and is locked on one end of the right second groove 53 on the push-pull rod 35 whereby driving the push-pull 35 to move to the left, and forcing the pump body 32 to move to the left along with the plunger 31. As shown in FIG. 6, as the end of the rotating block 37 contacted with the housing 36 slides to the middle part of the first groove 52 on the housing 36, since the middle part of the first groove 52 is lower than the other parts, rotation of the rotating block 37 cannot be limited, and the push-pull rod 35 is limited by the limit block 49 and cannot move to the left, the flow guide hole on the pump body 32 is connected to the outlet hole 40, and the inlet hole 39 is blocked by the pump body 32. The sliding block 34 continues to move to the left and drives the plunger 31 to move along therewith, the plunger 31 moves with respect to the pump body 32, and thus the liquid emission process is completed. Meanwhile, the right second groove 53 on the push-pull rod 35 drives the rotating block 37 to rotate, the end of the rotating block 37 contacted with the push-pull rod 35 slides in the left second groove 53 on the push-pull rod 35, the other end thereof contacted with the housing 36 slides to the left part of the first groove 52 on the housing 36, the spring piece 38 on the right of the rotating block 37 is compressed, and presses the rotating block 37 whereby enabling it to be tightly attached to grooves on both sides thereof, and thus a complete operation process is finished.

Some auxiliary design can be added to the invention based on the above-mentioned embodiments whereby achieving different mixing effects for cocktail. A liquor outlet head is removably disposed outside the liquid outlet, a flow guide portion is disposed on the liquor outlet head, and an end of the flow guide portion is contacted with inner wall of a wine glass. The liquor outlet head operates to slow down an outflow velocity of liquid, so that the liquid slowly flows along the inner wall of the wine glass after being guided via the flow guide portion and thus cocktail with different layers is produced. In addition, a magnetic stirrer is disposed at the liquor outlet 11, and comprises a motor, and a magnet driven by the motor. During mixing of liquor, the magnetic stirrer drives a stirrer containing metal materials in the wine glass to rotate so that mixing and stirring are simultaneously completed. An electric mixer is disposed on one side of the liquor outlet, and comprises a stirrer 7 driven by a stirring motor 6 and operating to uniformly mix cocktail. A touch screen 10 is disposed on the frame, and makes it convenient for a user to input information to the programmable control unit.

While particular embodiments of the invention have been shown and described, it shwill be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An cocktail maker, comprising
a frame;
multiple can bodies;
a multi-channel switching device comprising a liquid inlet and a liquid outlet;
a measuring pump comprising an inlet hole and an outlet hole;
a pipe system; and
a programmable control unit;
wherein
said can body is disposed on said frame;
said pipe system operates to connect said can body with a liquor outlet;
said can body is connected to said liquid inlet of said multi-channel switching device via a first honeycomb duct;
said liquid outlet of said multi-channel switching device is connected to said inlet hole of said measuring pump via a second honeycomb duct;
said outlet hole of said measuring pump is connected to a liquor outlet; and
a drive portion of said multi-channel switching device and said measuring pump is electrically connected to said programmable control unit.

2. The cocktail maker of claim 1, wherein
said measuring pump further comprises a pump sleeve, a pump body, a plunger, and a flow guide hole;
said pump body is movably disposed in said pump sleeve;
said plunger is disposed in a cavity of said pump body;
said flow guide hole is disposed on side wall of said pump body and connected to said cavity;
said inlet hole and said outlet hole are disposed on said pump sleeve; and
said flow guide hole is alternatively aligned with said inlet hole and said outlet hole.

3. The cocktail maker of claim 1, wherein
said multi-channel switching device comprises a first portion, a second portion, and a switching portion;
a liquid-inlet channel connected to said liquid inlet and said liquid outlet corresponding to said can body is disposed on said first portion;
a liquid outlet connected to said measuring pump, and a liquid-outlet channel connected to said liquid outlet are disposed on said second portion;
said switching portion is disposed between said first portion and said second portion, and capable of moving with respect thereto;
a flow guide channel is disposed on said switching portion;
one end of said flow guide channel is connected to said liquid-outlet channel on said second portion; and
the other end thereof is connected to a corresponding liquid-inlet channel as said switching portion is in different positions.

4. The cocktail maker of claim 3, wherein
said switching portion is in the shape of a circular plate and capable of rotating with respect to a central axis thereof; and
an end of said flow guide channel connected to said liquid-outlet channel is on said central axis of said switching portion.

5. The cocktail maker of claim 3, wherein
said can bodies are divided into N groups, and N is an integer greater than or equal to 1;
the number of said multi-channel switching devices and measuring pumps is N;
each group comprises a can body, a multi-channel switching device, and a measuring pump;
said can body in each group is connected to a liquid inlet of a corresponding multi-channel switching device via said first honeycomb duct; and
said liquid outlet of said multi-channel switching device is connected to an inlet hole of a corresponding measuring pump.

6. The cocktail maker of claim 3, wherein
said switching portion of said multi-channel switching device is driven by a servo motor, or a step motor with a rotary encoder; and
said servo motor or said step motor is closed-loop controlled.

7. The cocktail maker of claim 3, wherein
an evacuation channel inlet is disposed on said first portion of said multi-channel switching device;
said evacuation channel inlet is connected to purified water or ambient air, and to an evacuation channel in said first portion; and
said switching portion moves so that said flow guide channel connects said evacuation channel to said liquid-outlet channel of said second portion as said multi-channel switching device is in an evacuation state.

8. The cocktail maker of claim 3, wherein
a liquor outlet head is removably disposed outside said liquid outlet;
a flow guide portion is disposed on said liquor outlet head; and
an end of said flow guide portion is contacted with inner wall of a wine glass.

9. The cocktail maker of claim 1, wherein a magnetic stirrer and an electric mixer are disposed at said liquor outlet.

10. The cocktail maker of claim 1, wherein a cooling device is disposed outside said can body.

11. The cocktail maker of claim 1, wherein magnetic sealing is used between said first portion, said second portion, and said switching portion.

12. The cocktail maker of claim 1, wherein a rotatable liquor outlet head is disposed outside said liquid outlet, and an outlet of said liquor outlet head faces wall of the cup.
